(19) United States
(12) Patent Application Publication
(10) Pub. No.: US 2006/0005357 A1
(43) Pub. Date: Jan. 12, 2006

(54) Handle for a Handheld Working Tool

(75) Inventors: Ralf-Rainer Kemmler, Schwaikheim (DE); Andreas Guip, Waiblingen (DE)

Correspondence Address: GUDRUN E. HUCKETT DRAUDT, LONSSTR. 53, WUPPERTAL, 42289, DE

(73) Assignee: ANDREAS STIHL AG & CO. KG, Waiblingen (DE)

(21) Appl. No.: 11/160,293

(22) Filed: Jun. 17, 2005

(30) Foreign Application Priority Data
Jun. 22, 2004 (DE) 102004030158.1

(51) Int. Cl. B25G 1/10

(52) U.S. Cl. 16/430

(57) ABSTRACT

A handle of a hand-held working tool has a handle pipe made of a laminate with fiber-reinforced plastic material. The handle pipe is reinforced by a locally adjusted laminate structure at locations of high dynamic vibration-caused deformation energy, respectively. The laminate of the handle pipe has a base laminate and an additional laminate provided at the locations of high dynamic vibration-caused deformation energy. The additional laminate is applied to the exterior of the base laminate.

### BACKGROUND OF THE INVENTION

The invention relates to a handle of a handheld working tool (power tool) such as a motor chainsaw or the like, wherein the handle comprises a handle pipe that is manufactured of a laminate comprising a fiber-reinforced plastic material. The invention further relates to a working tool (power tool) having such a handle.

When operating a handheld working tool (power tool), such as a motor chainsaw, a trimmer or the like, mechanical vibrations occur that can be caused by the running of a drive motor or by the driven cutting tool. The working tool (power tool) is held by a handle and guided during operation of the tool by means of the handle. The mass of the working tool forms together with the elastically deformable handle a vibratory system that can be excited by the exciting vibrations of the motor or the cutting tool. These vibrations can be felt by the operator's hand that grips the handle and guides the tool. Excessive vibrations can cause the operator to experience untimely fatigue or can lead to an unsatisfactory work result.

Numerous designs of vibration damping measures are known with which a damping connection of the handle on the housing of the working tool (power tool) is provided. The vibrations that can be felt at the handle are to be dampened and reduced in this way. Japanese patent document 09037635 A discloses a handle of a handheld tea harvesting machine wherein the handle has a U-shape. The free legs of the U-shape are made of carbon fiber pipes that are connected to one another by means of a curved aluminum pipe. For damping the vibrations that occur, the curved aluminum pipe is covered with a vibration-damping hose.

### SUMMARY OF THE INVENTION

It is an object of the present invention to further develop a handle of a handheld working tool (power tool) such that in operation of the working tool a reduced vibration level occurs at the handle.

In accordance with the present invention, this is achieved in that the handle pipe is reinforced at locations of high dynamic vibration-caused deformation energy by means of a locally adjusted laminate structure.

The invention further has the object of providing a working tool (power tool) with reduced operating vibrations at the handle.

In accordance with the present invention, this is achieved in that the working tool (power tool) is provided with a handle having a handle pipe that is reinforced at locations of high dynamic vibration-caused deformation energy by means of a locally adjusted laminate structure.

Accordingly, a handle of a handheld working tool (power tool) is proposed that comprises a handle pipe or handle tube comprised of a laminate with fiber-reinforced plastic material, wherein the handle pipe at locations of high potential vibration-caused deformation energy is reinforced by a locally adjusted laminate structure. In the case of vibration excitation, a dynamic deformation line with antinodes and nodes is generated at the handle pipe. In these areas, an increased deformation energy by bending strain, lateral force deformation, and torsion is generated. The arrangement of a locally adjusted laminate structure in these areas leads to a targeted reinforcement in precisely these areas while in the areas of reduced deformation energy the additional mass of additional laminate layers is not required. The targeted reinforcement leads to an increase of the resonant frequency wherein the lack of additional laminate masses in the area of reduced deformation energy leads to an additional increase with regard to the resonant frequency of the vibratory system. The vibration system comprised of the working tool (power tool) and its handle has as a whole a minimal mass with high stiffness and, as a result of this, a high resonant frequency. The resonant frequency can be adjusted in a targeted way such that it is located remote from a dominant excitation frequency in operation of the working tool (power tool). A targeted detuning of the system is possible such that the vibration excitation by the drive motor and/or by the cutting tool leads to no or at most a minimal dynamic excess at the handle. This handle has a reduced vibration level.

The reinforcement of the handle pipe is advantageously designed such that the resonant frequency of the vibration system from the working tool (power tool) with the handle is outside of an excitation frequency range of the working tool under operating conditions and, in particular, above the operating speed of a drive motor of the working tool. During operation of the working tool (power tool), for example, under full load conditions, resonance vibrations at the handle are reliably prevented.

The laminate of the handle pipe is comprised advantageously of a base laminate that is made thicker at locations of high deformation energy particularly at its exterior side by means of an additional laminate. While causing only a minimal mass increase, a significant increase of the geometrical moment of inertia can be achieved. This provides a correspondingly marked reinforcement effect in all spatial directions with an increase of the resonant frequency of the vibration system.

In an expedient embodiment, the laminate is constructed to have a distribution about the circumference of the handle pipe such that the handle pipe in the direction of an increased dynamic bending load is stiffer than transversely thereto. At locations of increased dynamic torsion there is advantageously a fiber angle of the laminate of approximately +/−45 degrees relative to a pipe axis of the handle pipe. The increased resistance to bending can be achieved, for example, by a targeted incorporation of a laminate layer with fibers that extend unidirectionally in the longitudinal direction while the increased shear deformation, for example, in the form of lateral force and/or torsion is taken up effectively by the fiber positioned at +/−45 degrees. With only minimal laminate cross-sections an adjusted high stiffness can be achieved that, in connection with the minimal laminate mass, increases in a desirable way the vibratory system.

In advantageous embodiments, the handle pipe has distinctly curved sections as well as attachment sections that are reinforced, respectively, by appropriate reinforcement elements. It was found that the aforementioned areas are subjected to high dynamic bending strain, lateral force loads, and torsional loads, and a targeted reinforcement of these areas can raise the resonant frequency of the vibration system in a targeted way. The other areas of the handle pipe can remain without reinforcement. Additional weight in these areas and a thickening of the cross-section are not required. The handle pipe can maintain in these other areas an ergonomically beneficial base cross-section. In particular, the reinforcement of the attachment section is continued past this section in a direction of further extension of the handle pipe. This preferred configuration takes into account that the immediate area of the attachment section is loaded excessively by shearing forces and the like while the neighboring area is loaded excessively by bending strain, lateral force loads and torsional loads. The area of increased load is therefore appropriately reinforced in a targeted way.

In an advantageous further embodiment, the laminate contains carbon fibers and is comprised in particular of a plastic material containing exclusively carbon fibers. This provides a beneficial ratio of stiffness to mass with a correspondingly high resonant frequency.

### BRIEF DESCRIPTION OF THE DRAWING

One embodiment of the invention is disclosed in more detail in the following with the aid of the drawings.

FIG. 1 is a perspective general illustration of a handheld working tool (power tool) in the form of a motor chainsaw with a handle pipe.

FIG. 2 is a side view of the handle pipe according to FIG. 1 illustrating the handle pipe under dynamic operating load.

FIG. 3 is a front view of the handle pipe according to FIG. 2 with a locally arranged additional laminate.

FIG. 4 is a schematic illustration of a cross-section of the handle pipe according to FIGS. 2 and 3 in the area of the additional laminate.

FIG. 5 is a side view of the arrangement according to FIG. 4 with details of diagonally positioned laminate fibers.

### DESCRIPTION OF THE PREFERRED EMBODIMENTS

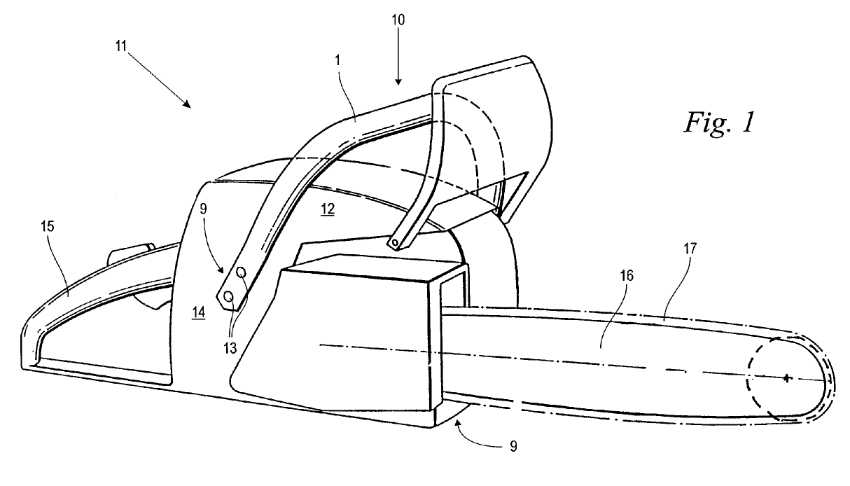

FIG. 1 shows in a perspective illustration a handheld working tool (power tool) 11 in the form of a motor chainsaw. The working tool 11 has a motor housing 14 in which a drive motor 12, not shown in detail, is arranged. A guide bar 16 projects from the motor housing 14; a saw chain 17 driven by the drive motor 12 is guided in circulation about the guide bar 16. A rear handle 15 is arranged at the rear area of the motor housing 14 opposite the guide bar 16. A front handle 10 comprises a handle pipe or handle tube 1 that partially surrounds the motor housing 14 near the center of gravity. The handle pipe 1 has two attachment sections 9 arranged at a lateral surface of the motor housing 14 and in the area of the bottom of the working tool 11; the handle pipe 1 is attached by means of screws 13 with the attachment sections to the motor housing 14.

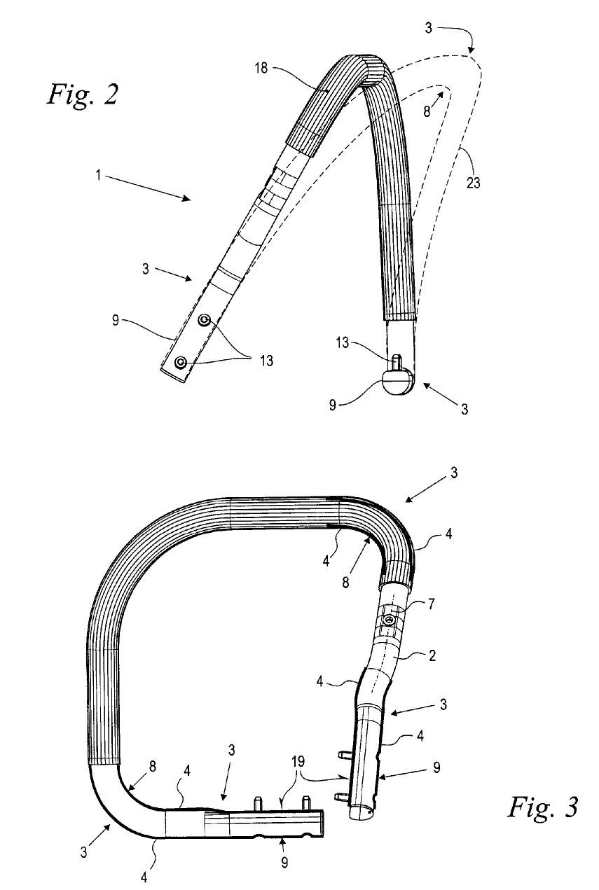

FIG. 2 shows in a side view details of the handle pipe 1 according to FIG. 1. The handle pipe 1 is covered by a grip hose 18 in the grip area. In the area of the grip hose 18 near the center of gravity of the working tool 11 (FIG. 1), the handle pipe 1 is held in operation; a dynamic vibrating deformation of the handle pipe 1 occurs by vibration excitation caused by the drive motor 12 and/or by the saw chain 17 (FIG. 1). A first basic shape of the vibrating deformation of the handle pipe 1 is illustrated by dashed lines 23 (FIG. 2) wherein the handle pipe 1 has various locations 3 of high dynamic vibration-caused deformation energy. Such locations 3 are generated in the distinctly curved sections 8 and in the area of the attachment sections 9 and screws 13 of the handle pipe 1.

FIG. 3 shows in a front view the handle pipe 1 according to FIG. 2. As illustrated in FIG. 3, the handle pipe 1 is reinforced by means of a locally adjusted laminate structure 4 at the locations 3 of high dynamic vibration-caused deformation energy, respectively. These locations 3 are formed by the two attachment sections 9 with the adjoining areas as well as by two distinctly curved sections 8. The attachment sections 9 extend across an area providing contact surfaces 19 which rest in the mounted state on the motor housing 14 (FIG. 1).

The adjusted reinforced laminate structure 4 is extended past the attachment sections 9 in the direction of the further extension of the handle pipe 1 wherein the reinforcement of the lower attachment sections 9 and of the adjoining curved areas 8 pass into one another.

The handle pipe 1 is reinforced at the locations 3 of high dynamic vibration-caused deformation energy by means of a locally adjusted laminate structure 4 while the remaining areas of the handle pipe 1 are comprised of the basic handle pipe 1 without reinforcement.

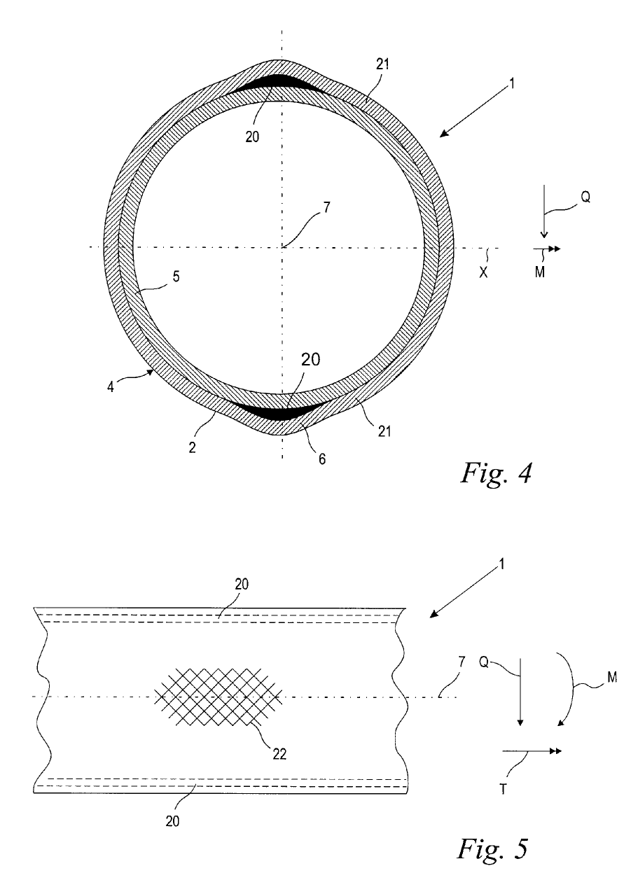

FIG. 4 shows in a schematic illustration a cross-section of the handle pipe 1 according to FIG. 3 showing that the handle pipe 1 in the sections that are not reinforced (FIG. 3) is comprised of a base laminate 5. In the areas of the adjusted laminate structure 4, an additional laminate 6 is applied to the exterior of the base laminate 5. The additional laminate 6 is comprised in the illustrated embodiment of a cover layer 21 and two unidirectional layers 20 that, relative to the cross-sectional axis, are opposed to one another. The base laminate 5 and the additional laminate 6 together define the laminate 2 that is manufactured of a fiber-reinforced plastic material, wherein the fiber-reinforced plastic material in the illustrated embodiment contains exclusively carbon fibers. It is also possible to provide a mixed laminate or a laminate of a single type of fiber of other fiber materials such as glass fibers and/or aramid fibers.

The cover layer 21 provides a thicker portion distributed about the circumference of the handle pipe 1 or the base laminate 5 so that the handle pipe 1 has an increased torsional stiffness about the pipe axis 7 as well as an increased bending stiffness about the cross-sectional axis X and transversely thereto. The fibers in the unidirectional layers 20 extended parallel to the pipe axis 7. The additional laminate 6 of the laminate 2 is therefore constructed in distribution about the circumference of the handle pipe 1 such that the handle pipe 1 is stiffer in the direction of increased dynamic bending strain caused by a bending moment M acting about the cross-sectional axis X than transversely thereto. The longitudinal stress loads within the laminate 2 resulting from the bending moment M are taken up essentially by the unidirectional layers 20 while the shear stresses that are caused by a lateral force acting transversely to the cross-sectional axis X are primarily taken up by the base laminate 5 and the cover layer 21.

FIG. 5 shows in a schematic side view a section of the handle pipe 1 according to FIG. 4; FIG. 5 shows that the unidirectional layers 20 for taking up the bending moment M have an appropriate radial spacing to the pipe axis 7. Corresponding to the line grid 22, the fibers of the base laminate 5 and the cover layer 21 (FIG. 4) are positioned at a fiber angle of approximately +/−45 degrees relative to the pipe axis 7. In this way, the increased torsional loads can be effectively taken up as a result of an increased dynamic torsional moment T. The fiber layers are expediently aligned in accordance with the main stress orientation. Shear loads as a result of an increased dynamic lateral force Q are taken up by the doubled laminate structure 4 comprising the base laminate 5 and the cover layer 21 (FIG. 4), wherein a fiber angle of +/−45 degrees relative to the pipe axis 7 is also advantageous.

The reinforcement of the handle pipe 1 according to FIGS. 1 to 5 is designed such that the resonant frequency of the vibration system from the working tool 11 with the handle 10 (FIG. 1) is, for example, approximately 230 Hz. The operating speed of the drive motor 12 according to FIG. 1 under full load and with the saw chain 17 immersed into the material to be cut corresponds to an excitation frequency of approximately 200 Hz wherein the resonant frequency of the vibration system of approximately 230 Hz is above the operating speed or excitation frequency of the drive motor 12.

While specific embodiments of the invention have been shown and described in detail to illustrate the inventive principles, it will be understood that the invention may be embodied otherwise without departing from such principles.

What is claimed is:

1. A handle of a hand-held working tool, the handle comprising:
a handle pipe comprised of a laminate comprising a fiber-reinforced plastic material;
wherein said handle pipe is reinforced by a locally adjusted laminate structure at locations of high dynamic vibration-caused deformation energy, respectively.

2. The handle according to claim 1, wherein said laminate of said handle pipe is comprised of a base laminate and an additional laminate provided at said locations of high dynamic vibration-caused deformation energy.

3. The handle according to claim 2, wherein said additional laminate is applied onto an exterior of said base laminate.

4. The handle according to claim 1, wherein said laminate, about a circumference of said handle pipe, is constructed such that the handle pipe is stiffer in a direction of increased dynamic bending stress than in a direction transverse to said direction of increased dynamic bending stress.

5. The handle according to claim 1, wherein at locations of increased high dynamic torsional loads a fiber angle of fibers of said fiber reinforced plastic material is approximately +/−45 degrees relative to a pipe axis of said handle pipe.

6. The handle according to claim 1, wherein said handle pipe has distinctly curved sections, wherein at least one of said distinctly curved sections is provided with said locally adjusted laminate structure.

7. The handle according to claim 1, wherein said handle pipe has an attachment section that is reinforced by said locally adjusted laminate structure.

8. The handle according to claim 7, wherein said locally adjusted laminate structure extends past said attachment section in a direction of a further extension of said handle pipe.

9. The handle according to claim 1, wherein said fiber-reinforced plastic material of said laminate comprises carbon fibers.

10. The handle according to claim 9, wherein said fiber-reinforced plastic material of said laminate contains exclusively carbon fibers.

11. A working tool comprising a handle that comprises a handle pipe comprised of a laminate with fiber-reinforced plastic material, wherein said handle pipe is reinforced by a locally adjusted laminate structure at locations of high dynamic vibration-caused deformation energy, respectively.

12. The working tool according to claim 11, wherein said handle pipe is reinforced such that a resonant frequency of a vibration system of said working tool and said handle is detuned into a range outside of an excitation frequency range of said working tool under operating conditions.

13. The working tool according to claim 12, wherein said range is above an operating speed of a drive motor of said working tool.
